(19) United States
(12) Patent Application Publication
(10) Pub. No.: US 2002/0055910 A1
(43) Pub. Date: May 9, 2002

(54) PROGRAM COMPONENT DISTRIBUTION

(76) Inventor: DAVID JOHN DURBIN, WINCHESTER (GB)

Correspondence Address: LAWRENCE E. ASHERY, ESQ., RATNER & PRESTIA, P. O. BOX 980, VALLEY FORGE, PA, 19482-0980, US

(21) Appl. No.: 09/394,550

(22) Filed: Sep. 10, 1999

(30) Foreign Application Priority Data
Sep. 10, 1998 (GB) 9819811.2

(51) Int. Cl. G06F 17/60

(52) U.S. Cl. 705/64

(57) ABSTRACT

There is described a method of loading a Java class component for a Java application running on a Java Virtual Machine comprising the steps of: downloading the class from local memory or an remote server; checking the class for encryption of one or all of the methods; checking whether an encrypted class has been paid for; sending payment for a non paid up class to a remote clearing server which acts as a central depository for payments; downloading an encryption key for the paid up encrypted class from the clearing server; and decrypting the paid up encrypted class with the key.

### FIELD OF INVENTION

This invention relates to program component distribution. In particular it relates to super distribution of class components.

### BACKGROUND OF INVENTION

A major issue for software engineers is how to protect their programs from being copied and used by an unauthorised person. Normally the source code is kept confidential and only the object code is distributed to users. For instance, C++ code is compiled into low level machine object code which when reverse engineered or decompiled losses much of its useful information regarding address labels, variable labels and comments which exist in the source code. As such, much work is needed to analyze and understand the workings of such code. However a problem exists for interpreted languages such as Java as the source code is compiled into Java Virtual Machine byte code, a much higher level of object code than C++ object code. The byte code retains much of the label and variable information which makes it easy to understand and allows copying or re-use to be performed with less effort.

Encryption of the program code is one solution. Byte code is encrypted with a key before it is distributed and then decrypted before it is run by the user. Java Virtual Machines with decryption components already exist to perform such functions. This makes it harder for an unauthorised person to intercept the code and decompile for reverse engineering, since first he must obtain the correct key and the encryption method used on the code.

Distribution of digital information is another issue for software engineers. A traditional method of distribution is for each end user to make a payment to a distributor before receiving a package directly from a distributor. However this does not allow users to test the package before they buy it. Another method is to make available freeware versions of a package having a restricted set of functions or a limited life span. If the user likes what he sees he can then purchase and receive a full version. This allows people to distribute packages to friends and contacts without restriction but means that the end user has to go back to the distributor to receive and pay for the full version. Furthermore two versions of the software have to be distributed. Another method is super distribution. The idea is that digital information is freely available over the internet by diskettes or other sources as long as it is encrypted. Assuming that the encryption process is sufficiently secure, the only way to a user can have access to the information is to purchase a necessary PEK (part encryption key) that is typically orders of magnitude more compact than the documents it decrypts. Super distribution is a powerful concept because it decouples the problem of information distribution into the distribution of bulk data and the controlled release of the content through the release of PEKs.

US patent publication 5673316 discloses a method and apparatus to create, distribute, sell and control access to digital documents using secure cryptographic envelopes. An envelope is an aggregation of information parts, where each of the parts to be protected is encrypted with a corresponding part encryption key. These encrypted information parts along with the other information parts become part of the envelope. Each part encryption key is also encrypted with a public key, and these encrypted part encryption keys are also included in the envelope. The envelope also includes a list of parts where each entry in the list has a part name and a secure hash of the named part. The list is then signed with a secret key to generate a signature, which is also included in the envelope. The signature can be verified using a second public key associated with the first secret key, and the integrity of any information part in the envelope can be checked by computing a second hash and comparing it with the corresponding hash in the list of parts. Also, the information content of any encrypted part can only be recovered by knowledge of a second secret key corresponding to the public key that was used to encrypt the part encryption keys. This disclosure deals mainly with document information and not with program code.

Other publications describe cryptographic techniques and super distribution including: Applied Cryptography, 2nd edition Addison Wesley, 1996—B. Schneier; and Superdistribution and Electronic Objects, Dr Dobb's Journal Vol 17, no. 10 October 1992.

### SUMMARY OF INVENTION

According to one aspect of the invention there is provided a method of loading a class component for running on a virtual machine comprising the steps of: downloading the class; checking the class for encryption; checking an encrypted class for payment; sending payment for a non paid up class; downloading an encryption key for the paid up encrypted class; and decrypting the paid up encrypted class with the key.

Dynamic distribution of Java code and the rapid adoption of Java Beans component model has lead to a large number of Java Beans being available commercially. Whilst developers may be prepared to pay a commercial license fee for a Java Bean which they wish to reuse, without any idea of how many units of their product they may sell it can be hard to determine how much they can spend on a given Java Bean. A better model would be to encourage ‘pay-per-use’ of Java Beans by the end user. In this way, developer fees could be dropped and there would be more incentive to produce and reuse beans.

With cryptolopes, IBM have proven technology for distributing on a pay-per-use model. The latest advances include pure Java implementations of the cryptolope viewer. By incorporating cryptolope technology into a Java class loader (either integrated with a JVM or as an add-on) Java Bean developers can specify a cost for usage which would be collected at run time when a bean was retrieved from a server. Paying the requisite fee would result in the classes involved being decrypted and made available for execution.

In addition to the financial benefits, the use of encryption for beans in transit would mount a serious obstacle to decompilation attacks.

Spin off services would include running a ‘bean library’ where developers would submit beans and allow a service provider to run a cryptolope server, collect payments and pass them on to the bean provider (after the deduction of a small commission).

The class may be downloaded from a computer disk or diskette or from a network. This gives flexibility for the way in which the class files may be distributed.

The class may contain a flag for indicating that the class is an encrypted class. This may be an existing flag within a standard class or flag formed as an attachment or header to the class.

The virtual machine records information pertaining to those classes for which payment has been received, if no information exists for a class then a presumption of non payment is made. Alternatively or as well as, a clearing server connected to the virtual machine over a network records information pertaining to those classes for which payment has been received.

If a class has not been paid for then a request is made for payment. Preferably the request is an on-screen prompt asking for credit card details or an account number or another on-line payment method. The user may enter the payment details and initiate a transaction. Such a transaction is conducted between a clearing server and the virtual machine by exchanging network messages.

A valid payment is acknowledged by the clearing server and recorded by the virtual machine, the clearing server or both. When a class is paid up the decryption key may be downloaded from the clearing server.

Advantageously the key may be a symmetrical decryption key. This type of key can both encode and decode and is a faster way of performing decryption than with a asymmetrical key.

Even more advantageously, a request is made to the clearing house server for the symmetrical key and together with this key request is sent the public part of a non-symmetrical key. The symmetrical key is encrypted using the public key and received by the VM which uses the private key part of the non-symmetrical key to decrypt the symmetrical key. In this fashion, only the VM which has paid for the class can use the symmetrical key to decrypt the class. Other parties which receive the symmetrical key have no way of decrypting it so that it may be used.

The class may be attached to a header, the class being encrypted and the header containing unencrypted information pertaining to the class. Preferably the header information contains the server name and the package or application to which the class belongs to.

Alternatively several classes may be encapsulated together with a header. One or more of the classes may be encrypted and preferable only the important or sensitive classes are encrypted so to save processing time on the JVM.

The method is preferably performed by the class loader of the JVM, the class loader being specially adapted to comprise the decryption components necessary to perform the method.

In another embodiment the method is preferably performed by an add-on component to the JVM, the class loader within the JVM detects that the class is an encrypted class and passes control to the add-on component.

In a second aspect of the invention there is provided a class loader for a virtual machine comprising: means for down loading a class; means for checking the class for encryption; means for checking an encrypted class for payment; means for requesting payment for a non paid up encrypted class; and means for decrypting the class with the key.

In a third aspect of the invention there is provided a computer readable storage medium storing computer program code, said computer program code for loading a class component onto a virtual machine comprising the steps of: downloading the class; checking class for encryption; checking an encrypted class for payment; sending payment for a non paid up class; downloading an encryption key for the paid up encrypted class; and decrypting the paid up encrypted class with the key.

### BRIEF DESCRIPTION OF DRAWINGS

This and other aspects of the present invention will now be described, by way of example only, with reference to the following figures in which:

FIG. 1 is a schematic representation of a Java Virtual Machine on a client platform, a class server and a clearing server, all connected to a network;

FIG. 2 is a schematic representation of the components in a class loader in the Java Virtual Machine of the embodiment;

FIGS. 3A and 3B are schematic representations of two different embodiments of Java class components;

FIG. 4 is a flow diagram of the process of downloading an encrypted class of the present embodiment;

FIG. 5 is schematic representation of a path taken by a java class component from a developer to a user.

### DETAILED DESCRIPTION OF PREFERRED EMBODIMENT

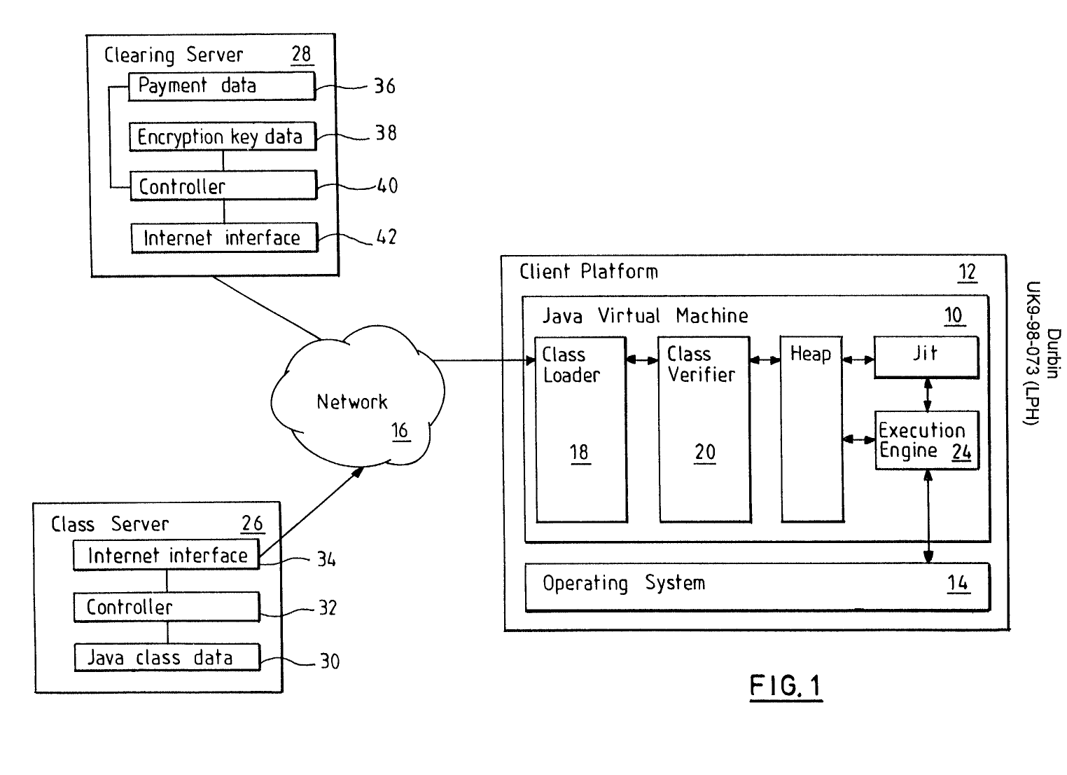

A Java Virtual Machine (JVM) 10 resides an a client platform 12 together with a platform operating system 14, the platform 12 is connected to a network 16 (see FIG. 1). The client platform 12 may be a pentium based microprocessor system. The JVM 10 comprises a class loader 18 for loading Java classes, a class verifier 20 connected to the class loader 18 for verifying that the class is a valid class for running on the JVM 10; a heap 22 for putting the classes once they have been verified; an execution engine 24 for interpreting the Java classes and executing them in conjunction with the operating system 14 and client platform hardware. Also connected to the network 16 is a class server 26 which stores the encrypted Java classes ready for downloading to the client platform 12 on request and a clearing server 28 which stores the keys for decrypting the encrypted Java classes.

The class server 26 may be a pentium or RISC based microprocessor system having an operating system, a database of encrypted Java class components 30, a class server controller 32 and an internet interface 34 for downloading the Java class components to clients who request them. When the client begins to execute an applet or application containing a class that is located on the class server 26, the client requests the class server 26 to download the class. The server controller 32 receives the request through the internet interface 34, locates the encrypted class in the Java class database and sends it to the client.

The clearing server 28 may be a pentium or RISC based microprocessor having an operating system, a payment database 36, a key database 38, a clearing server controller 40 and an internet interface 42. When the client receives an encrypted class from the class server it needs to decrypt it with a key located on the clearing server 28. To receive such a key from the clearing server 28 the client must pay for it by negotiating with the clearing server through the internet interface 42. Payment details are stored on the clearing server in the payment database 36, the respective encryption key is located in the key database 38 and sent to the client.

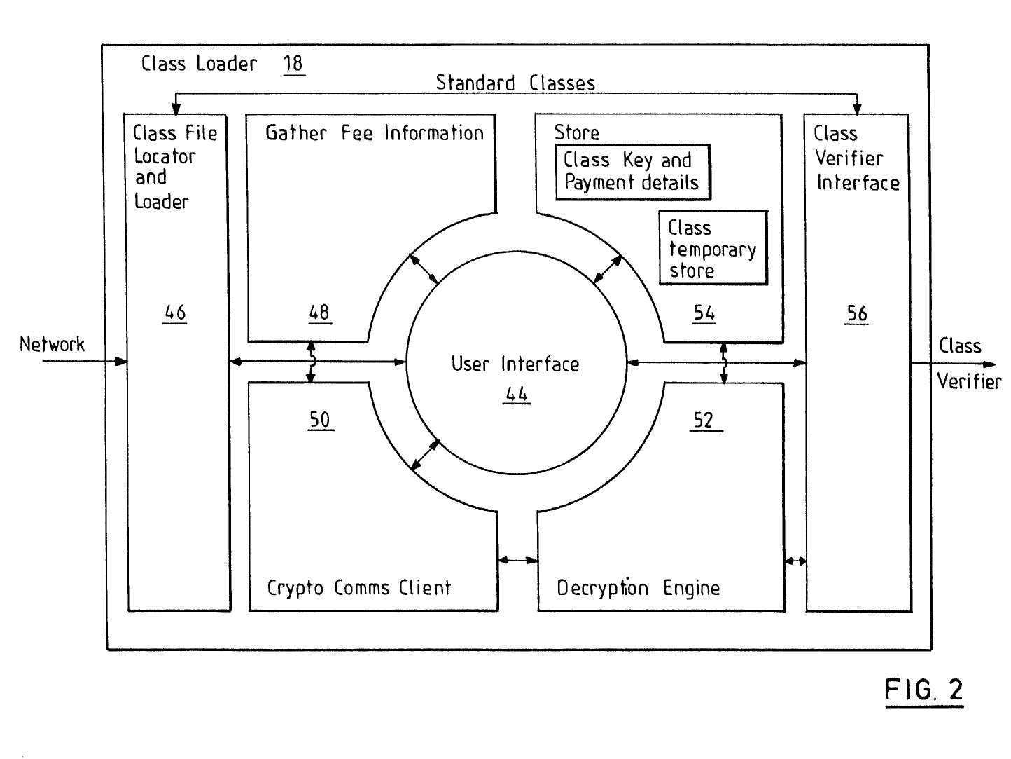

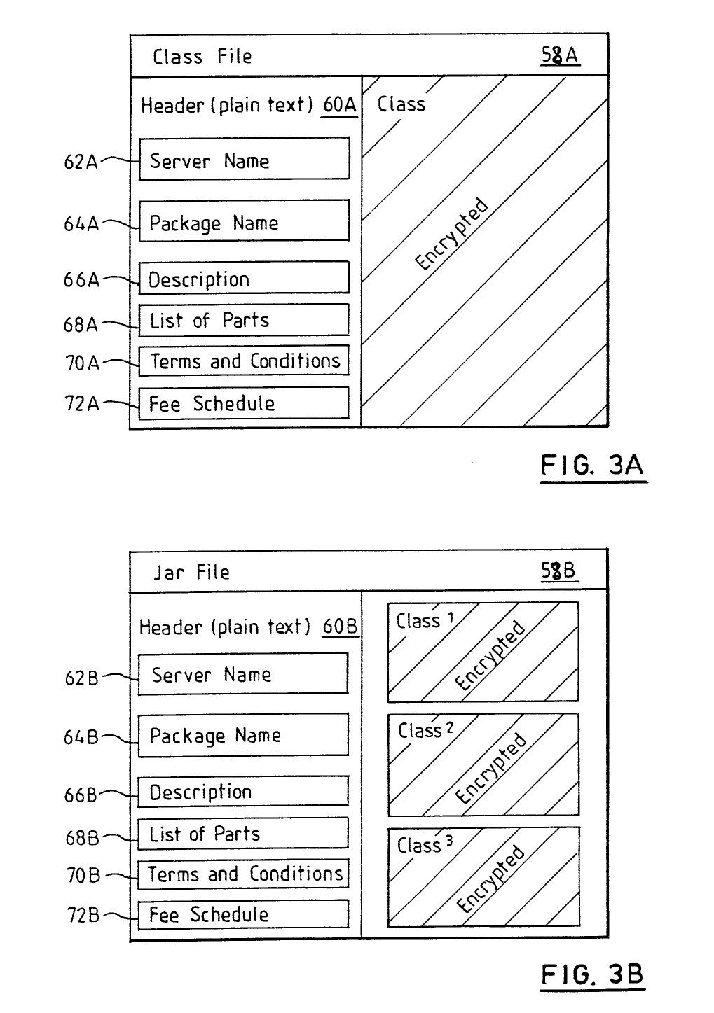

The class loader 18 is the component of the JVM 10 which locates and brings into executable memory necessary program components (classes) needed to run a program. It performs a similar function to dynamically loaded components of an operating system. Classes are located in different places and may be treated differently depending on where they originate from. In general classes can be divided into three categories: core Java API classes; local classes; and network classes. Core Java API classes are shipped with the JVM and provide access to network, GUI and threading functions. They are shipped with the JVM and are part of the Java specification, as such they are treated as trusted classes and minimum checks are performed on them to ensure their validity. Classes are also found on the local filing system having been downloaded or installed by the user in the past; these classes are treated in the same way as classes in the core Java API. The third category of classes is those loaded from other sources, for instance, an applet loaded from a web server. It is these classes which are of most interest to this invention. These classes are treated with the most caution by the JVM 10. The class loader 18 of the embodiment comprises: a user interface 44; a class file locator and loader component 46; a gather fee information component 48; a crypto comms client 50; a decryption engine 52; a payment store 54 and a class verifier interface (see FIG. 2). An encrypted class is described below with reference to FIG. 3. A pay-for-use class is a class that requires payment before it can be used, in the embodiment such a class will be encrypted to stop unauthorised use.

The user interface component 44 is used when a class that has been downloaded is found to be a pay-for-use class that has not been paid for. The user interface 44 prompts the user for payment details and other information required by the clearing server 28. For instance, before the class loader can decrypt the class, the clearing server 28 must have registration details, payment details, and package information from the user. The user interface 44 prompts the user, accepts input and passes this information to the crypto comms client 50 for sending to the clearing server.

The class file locator and loader component 46 performs some of the function of a prior art class loader; it also checks whether a class it is downloading is an encrypted class and whether the class belongs to a package that has already been paid for. Further, it may unpack a class or number of classes from a packed class or a packed bundle of classes (a Jar). The class file locator and loader component 46 connects to the class file verifier interface 56 for passing on standard classes that require no decryption.

The cryptolope comms client 50 understands and manages cryptolope key exchange protocol and handles all communications with the clearing server 28. The cryptolope key exchange protocol is described in more detail in the prior mentioned references.

The decryption engine 52 decrypts encrypted class file using a symmetrical key as opposed to an asymmetric key. Symmetrical decryption uses the same key to encrypt a class file at one end of a transmission and decrypt it at the other end. One consequence of this is that symmetrical encryption is less secure than asymmetrical. However the advantage of symmetrical encryption is that it is quicker and with many classes to decrypt this can be a significant factor.

The payment store 54 records payment details, for instance, which classes have been paid for and the duration. A class may need to be paid for each time it is downloaded or only once ever. A new payment may also need to be made periodically. Other classes may be free once payment has been accepted. In the preferred embodiment only the first class of a package is encrypted and will initiate the payment of the entire package, once paid for this class and the remaining classes of the package may be loaded without decrypting.

The gather fee information component 48 stores information relating to payment options such as single payment-multiple use, payment for each usage, and scaled payment for level of use.

The class file verifier 56 interface takes decrypted classes from the decryption engine and standard class files from the class file locator and loader and pushes them on to the class file verifier.

Structure of a Class File and Jar File

The code structure described in the preferred embodiment is a cryptolope encrypted class file 58A comprising an encrypted class with a plain text header 60 (see FIG. 3A). The header 60A comprises information for use with the class file including: clearing server name 62A; package name 64A; description 60A; list of parts 68A; terms and conditions 70A; and fee schedule 72A. The clearing server name 62A is the address and location of the clearing house server 28 which has the symmetric key for decrypting the encrypted class, in this case the clearing server 28 is located somewhere on the internet and the address is a universal resource locator (URL) of the form http:/ . . . which points to the world wide web. The package name 64A is needed by the clearing server 28 to identify the correct symmetrical key to send to the user. The description 66A of the class and its function within the package is for the user to assess whether to proceed with the purchase of the class to enable the package. It maybe that the package can not work without the class and needs it to run properly or may be the package is only partially enabled with or without the class. The list of parts 68A may describe what the user receives in terms of classes and their function within the package. Terms and conditions 70A would include standard copyright terms and conditions of use of the package and any additional legal requirements. The fee schedule contains the fee information for the class that is to be used. The fees for supplementary classes may also be contained as well as any marketing information.

Another code structure used in another embodiment is a crytolope encrypted jar file 58B comprising a number of classes, at least one of which is encrypted using a symmetrical key and a plain text header 60B (see FIG. 3B). The header contains a server name 62B, package name 64B, description 66B, list of parts 68B, terms and conditions 70B and a fee schedule 72B. It is not necessary to encrypt all the classes in the jar as decrypting them all would add to processing time, only an essential class need be encrypted to stop the product from functioning. Other classes are encrypted if decompilation needs to be hindered. Another embodiment may only include a server name 62B and package name 64B in the header information and the rest of the header information is fetched from the clearing house 28 server before the symmetrical key is requested. This allows the class file 58B and jar file 58B to remain unmodified on the web server and only the clearing house information needs be updated in the event of price changes or changes in the terms and conditions.

Operation of the Class Loader

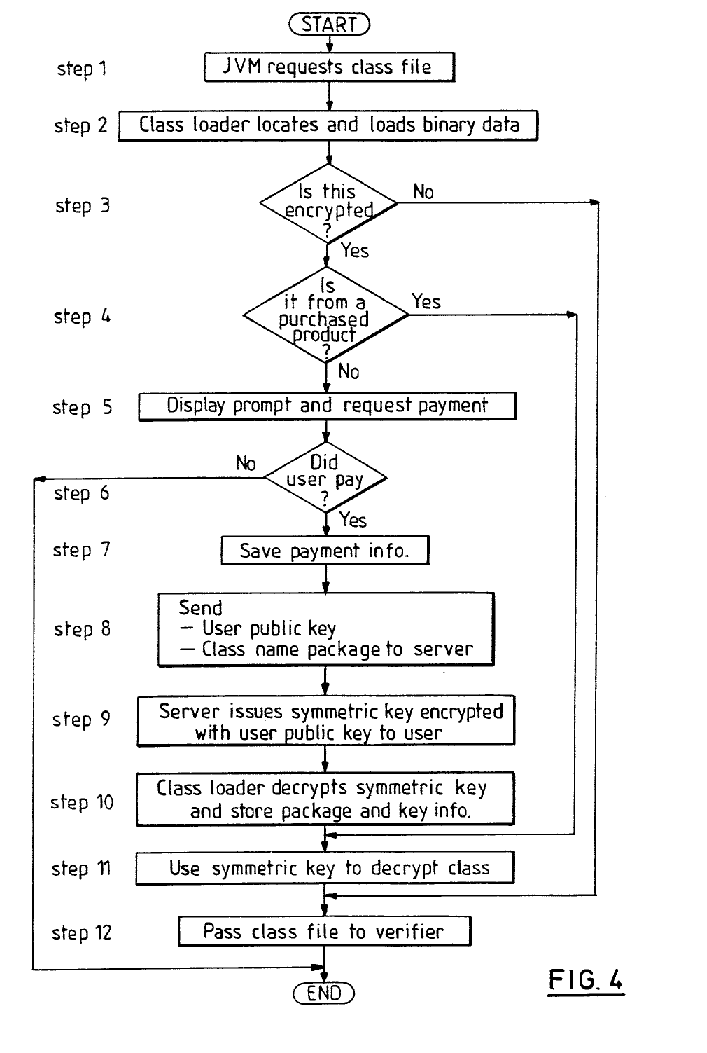

The operation of the embodiment is as follows (see FIG. 4). The operation assumes that a single class is cryptolope encrypted and is packed with a header containing server name information and package name information.

When the JVM requires a certain class file not located on the heap it makes a request to the class loader to locate and load the missing class (step 1).

The class loader locates the class, in this case it is found on the class server, and downloads the binary data it to the JVM where it is stored in a temporary memory (step 2).

The class file locator and loader checks to see (step 3) whether the class is cryptolope encrypted, if not the class is a standard class file and processing jumps to step 12 where the class is passed through the class file verifier interface to the class file verifier. If the class is an encrypted class then the process moves on to the next step.

The class loader checks to see if the class needs to be paid for (step 4); the class maybe an additional free class for a product that the user has already paid for, alternatively it maybe a supplementary class that needs an additional payment. Information regarding the charges for a product's classes is searched and it is determined whether a payment is necessary. This information is stored in the payment store. If no payment is necessary then the processing jumps to the decryption stage (step 11) to decrypt the class using a symmetric key determined from when the product was paid for. If a payment is necessary then processing moves to the next stage. Optionally at this stage, the user interface prompts the user to accept the terms and conditions before the symmetrical key is requested from the clearing house server (not shown or described).

The user interface displays a prompt to the user asking for payment for the class file or files (step 5); payment details such as a credit card number or account number will need to be entered or retrieved from a file on the client platform.

The cryptolope comms client sends the payment details to the clearing server and waits for acknowledgement (not shown). If the payment is accepted then the process moves (step 6) on to the next stage; if not then the process ends.

The class and payment details are saved in the payment store (step 7) where they maybe checked in future class loads.

The cryptolope comms client creates a public and private encryption key and sends the public key to the clearing server together with class and package name (step 8).

The clearing server encrypts the symmetric key for the class using the client public key and sends this encrypted symmetric key back to the client (step 9).

The cryptolope comms client receives the encrypted symmetric key and decrypts using the private key generated in step 8; the key is stored in the payment store (step 10).

The decryption engine uses the stored symmetric key to decrypt the class in the temporary class store (step 11). The process jumps here from step 4 if the class is ‘paid up’; in this case the decryption engine uses the symmetric key previously saved, for instance, from a time when a class belonging to the same package was paid for.

After the class has been successfully decrypted, the decryption engine passes it on to the class verifier interface to pass it on to the class verifier (step 12).

OVERVIEW

The Java class loader acts as a gateway to the JVM for all class files. By providing a class loader which incorporated the cryptolope player it would be possible to distribute Java class files in encrypted form. An overview is described in terms of an independent application that has been written in Java and which includes encrypted classes so that only part of the application is executable without payment. Such an application may run independently from a web browser on a JVM. However the invention is also relevant where all the classes of an application are encrypted so that the application is not executable without first paying for it. Furthermore the invention is relevant to independent applets that run in web browsers or single classes downloadable from the network that are form one component of an application.

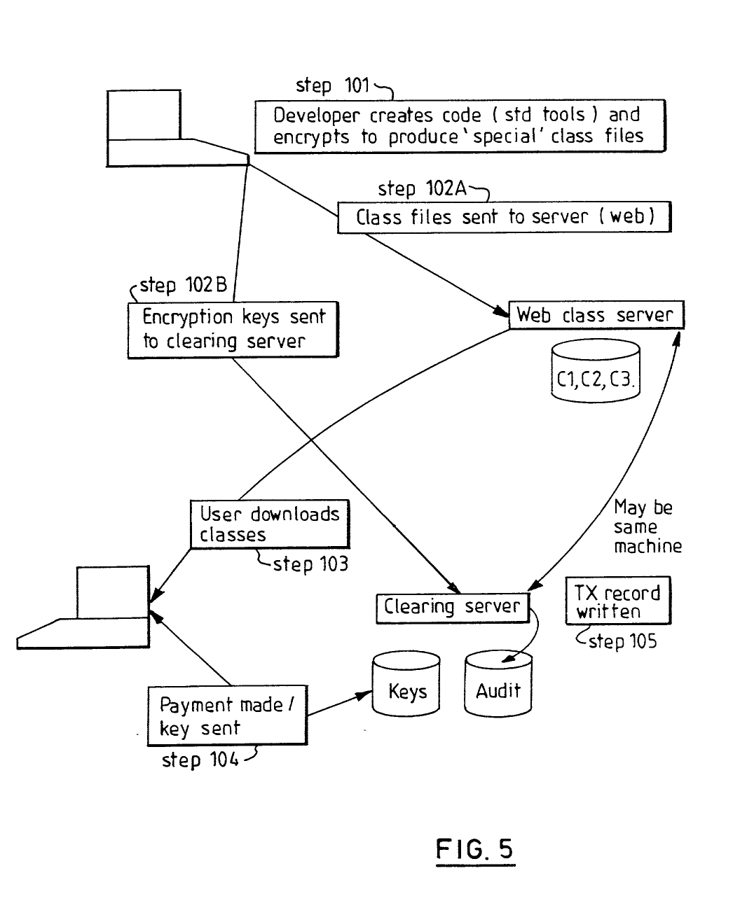

A developer creates a java application and encrypts certain class files within the application (step 101 in FIG. 5). The java application containing normal and encrypted class files are sent to a class server over the internet (step 102A) and a key to decrypt the class files is sent to the clearing server (step 102B). A user downloads the application (step 104) and makes a payment for the decryption key (step 105). The user may then run the application and the clearing server records the payment (step 105).

On being requested to load such a class, the modified class loader would determine that the class was included in a cryptolope and present a dialogue to the user informing them that this was a pay-per-use library and requesting credit card authorization or the like to ‘unlock’ the class. Following the standard cryptolope model, the user would then enter their payment authorization and this would be communicated back to the cryptolope clearing centre which would in turn issue a key to the class loader. The key would be used to decrypt the class file/JAR file in memory and then process the class in the conventional way, that is make it available for the JVM for execution. The key exchange protocol would preferably reuse existing cryptolope technology. A mechanism inside the class loader is necessary to allow flexibility of payment options such as single payment-multiple use, payment for each usage, scaled payment for level of use. These payment options would be specified using rights management language in place of Cryptolopes.

In summary there is described a method of loading a Java class component for a Java application running on a Java Virtual Machine comprising the steps of: downloading the class from local memory or a remote server; checking the class for encryption of one or all of the methods; checking whether an encrypted class has been paid for; sending payment for a non paid up class to a remote clearing server which acts as a central depository for payments; downloading an encryption key for the paid up encrypted class from the clearing server; and decrypting the paid up encrypted class with the key.

1. A method of loading a class component for running on a virtual machine comprising the steps of:
downloading the class;
checking the class for encryption;
checking an encrypted class for payment;
sending payment for a non paid up class and changing the encrypted class to paid up;
downloading an encryption key for the paid up encrypted class; and decrypting the paid up encrypted class with the key.

2. A method as claimed in claim 1 wherein the class may be downloaded from a server on a network.

3. A method as claimed in claim 2 wherein the class contains a flag for indicating that the class is an encrypted class.

4. A method as claimed in claim 3 wherein the flag is formed as an attachment or header to the class.

5. A method as claimed in claim 4 further comprising the step of recording information pertaining have classes for which payment has been received.

6. A method as claimed in claim 5 whereby if the class has been paid for a request for payment is made.

7. A method as claimed in claim 6 wherein the request for payment is an on-screen prompt asking for credit card details or an account number or another on-line payment method.

8. A method as claimed in claim 7 wherein the decryption key is a symmetrical decryption key.

9. A method as claimed in claim 8 wherein the decryption key is itself encrypted.

10. A method as claimed in claim 9 wherein the decryption key is encrypted using a public encryption key sent from the virtual machine with a request for the key.

11. A method as claimed in claim 10 wherein the class may be attached to a header, the class being encrypted and the header containing unencrypted information pertaining to the class.

12. A method as claimed in claim 10 wherein several classes may be encapsulated together with a header and the header containing unencrypted information pertaining to the classes.

13. A method as claimed in claim 12 wherein the method is preferably performed by the class loader of the JVM, the class loader being specially adapted to comprise the decryption components necessary to perform the method.

14. A method as claimed in claim 12 wherein the method is preferably performed by an add-on component to the JVM, the class loader within the JVM detects that the class is an encrypted class and passes control to the add-on component.
